(19) United States
(12) Patent Application Publication
(10) Pub. No.: US 2016/0055157 A1
(43) Pub. Date: Feb. 25, 2016

(54) DIGITAL INFORMATION ANALYSIS SYSTEM, DIGITAL INFORMATION ANALYSIS METHOD, AND DIGITAL INFORMATION ANALYSIS PROGRAM

(71) Applicant: UBIC, Inc., Tokyo (JP)

(72) Inventors: Masahiro Morimoto, Tokyo (JP); Hideki Takeda, Tokyo (JP); Akiteru Hanatani, Tokyo (JP)

(21) Appl. No.: 14/397,823

(22) PCT Filed: Mar. 17, 2014
(86) PCT No.: PCT/JP2014/057067

§ 371 Date: Oct. 29, 2014

(30) Foreign Application Priority Data
Oct. 11, 2013 (JP) 2013-213717

(51) Int. Cl. G06F 17/30

(52) U.S. Cl. CPC G06F 17/3053; G06F 17/30598

(57) ABSTRACT

A digital information analysis system includes: a relevance information acquiring unit that acquires relevance information attached by a classifier to each of multiple pieces of digital information; a relevance score calculating unit that calculates a relevance score determined according to relevance between each of the multiple pieces of digital information and the predetermined specific matter; a ratio calculation unit that calculates a ratio of the number of pieces of relevance information, attached to the digital information included in the range, to the total number of pieces of digital information having the relevance scores included in each range; and a display unit.

### TECHNICAL FIELD

This disclosure relates to a digital information analysis system, a digital information analysis method, and a digital information analysis program. Particularly, the disclosure relates to a digital information analysis system, a digital information analysis method, and a digital information analysis program that contribute to the evaluation of classification accuracy of a classifier who classifies digital information.

### BACKGROUND

Conventionally, a system has been known in which recorded digital information is displayed, user-specific information indicating to which user among users included in user information each of multiple document files has relevance is set, the set user-specific information is set to be recorded in a storage unit, at least one or more users are specified, user-specific information corresponding to the specified users searches for set document files, additional information indicating whether or not the retrieved document files are related to a legal action through a display unit is set and, based on the additional information, the document files relevant to the legal action are output (for example, see Japanese Patent Application Laid-Open No. 2012-181851). According to the system described in JP '851, only digital document information relating to specific persons can be extracted to reduce a workload of preparing evidentiary materials for the legal action.

In such a system as described in JP '851, it is believed that the classification accuracy can be improved since the classification results of a classifier who sets additional information for digital information are visually displayed.

Therefore, it could be helpful to provide a digital information analysis system, a digital information analysis method, and a digital information analysis program capable of evaluating the classification accuracy of a classifier.

### SUMMARY

We thus provide:
A digital information analysis system including: a relevance information acquiring unit for acquiring relevance information attached by a classifier to each of multiple pieces of digital information and indicative of relevance between the digital information and a predetermined specific matter; a relevance score calculating unit for calculating, for each of the multiple pieces of digital information, a relevance score determined according to relevance between each of the multiple pieces of digital information and the predetermined specific matter; a ratio calculation unit for calculating, for each predetermined range of relevance scores, a ratio of the number of pieces of relevance information, attached to the digital information included in the range, to the total number of pieces of digital information having the relevance scores included in each range; and a display unit for displaying multiple blocks associated with each range by changing hue, brightness, or saturation based on the ratio.

In the above digital information analysis system, the relevance information can include first relevance information indicating that the digital information and the predetermined specific matter have relevance to each other, and second relevance information indicating that the digital information and the predetermined specific matter have no relevance to each other, and the ratio calculation unit can calculate the ratio based on the number of pieces of first relevance information.

Further, in the above digital information analysis system, the relevance information acquiring unit can acquire the relevance information in association with a classifier identifier for identifying the classifier, and the display unit displays the multiple blocks for each classifier identified by the classifier identifier.

Further, in the above digital information analysis system, an attaching-time measurement unit for measuring a time to attach the relevance information to one piece of digital information can further be included, and the display unit can display a classification rate calculated from the time for each classifier identified by the classifier identifier.

Further, in the above digital information analysis system, a block selection unit for selecting any of the multiple blocks can further be included, and the display unit can display the digital information having the relevance scores included in the range corresponding to the block selected by the block selection unit.

Further, we provide a digital information analysis method including: a relevance information acquiring step of acquiring relevance information attached by a classifier to each of multiple pieces of digital information and indicative of relevance between the digital information and a predetermined specific matter; a relevance score calculating step of calculating, for each of the multiple pieces of digital information, a relevance score determined according to relevance between each of the multiple pieces of digital information and the predetermined specific matter; a ratio calculation step of calculating, for each predetermined range of relevance scores, a ratio of the number of pieces of relevance information, attached to the digital information included in the range, to the total number of pieces of digital information having the relevance scores included in each range; and a display step of displaying multiple blocks associated with each range by changing hue, brightness, or saturation based on the ratio.

We also provide a digital information analysis program for causing a computer to realize: a relevance information acquiring function of acquiring relevance information attached by a classifier to each of multiple pieces of digital information and indicative of relevance between the digital information and a predetermined specific matter; a relevance score calculating function of calculating, for each of the multiple pieces of digital information, a relevance score determined according to relevance between each of the multiple pieces of digital information and the predetermined specific matter; a ratio calculation function of calculating, for each predetermined range of relevance scores, a ratio of the number of pieces of relevance information, attached to the digital information included in the range, to the total number of pieces of digital information having the relevance scores included in each range; and a display function of displaying multiple blocks associated with each range by changing hue, brightness, or saturation based on the ratio.

According to the digital information analysis system, the digital information analysis method, and the digital information analysis program, a digital information analysis system, a digital information analysis method, and a digital information analysis program capable of evaluating the classification accuracy of a classifier can be provided.

### BRIEF DESCRIPTION OF THE DRAWINGS

FIG. 1 is a functional block diagram of a digital information analysis system according to an example.

FIG. 2 is a display screen of the digital information analysis system according to an example.

FIG. 3 is a partial schematic diagram of the display screen of the digital information analysis system according to an example.

FIG. 4 is a flowchart of processing performed by the digital information analysis system according to an example.

FIG. 5 is a hardware configuration diagram of the digital information analysis system according to an example.

### DESCRIPTION OF REFERENCE NUMERALS

1 digital information analysis system
2 information processing apparatus
10 input unit
12 information acquiring unit
14 relevance information acquiring unit
16 relevance score calculating unit
18 ratio calculation unit
20 attaching-time measurement unit
22 display control unit
24 display unit
26 block selection unit
260 display screen
262 display area
264 classification rate area
266 classifier column
266a classifier name
268 relevance score column
300 block
1500 CPU
1510 chipset
1520 graphics controller
1530 memory
1540 storage device
1545 reading/writing device
1550 communication interface
1560 input device

### DETAILED DESCRIPTION

### Outline of Digital Information Analysis System 1

A digital information analysis system 1 according to an example is a system that attaches relevance information, which indicates whether each digital information has relevance to a predetermined specific matter, to multiple pieces of digital information stored in an information processing apparatus 2 such as a user terminal or a server, and a system that visually displays the classification accuracy of each classifier who attaches relevance information to show whether proper relevance information is attached to the digital information.

The predetermined specific matter is information indicative of being relevant to a lawsuit, for example. Then, the digital information analysis system 1 can be applied to forensics as a technique in which, when a crime or a legal conflict related to computers occurs such as unauthorized access or leakage of confidential information, digital information as electronic records required for investigation into the cause of the crime or the legal conflict is collected and analyzed to reveal the legal evidence thereof.

Further, in the example, the server is one or more servers, which can also be configured to include multiple servers. For example, the servers include servers capable of storing digital information, such as e-mail servers, file servers, or document management servers. The user terminal is one or more user terminals, which can also be configured to include multiple user terminals. For example, the user terminals include portable communication terminals such as personal computers, laptop personal computers, tablet PCs, or cell-phones.

### Details of Digital Information Analysis System 1

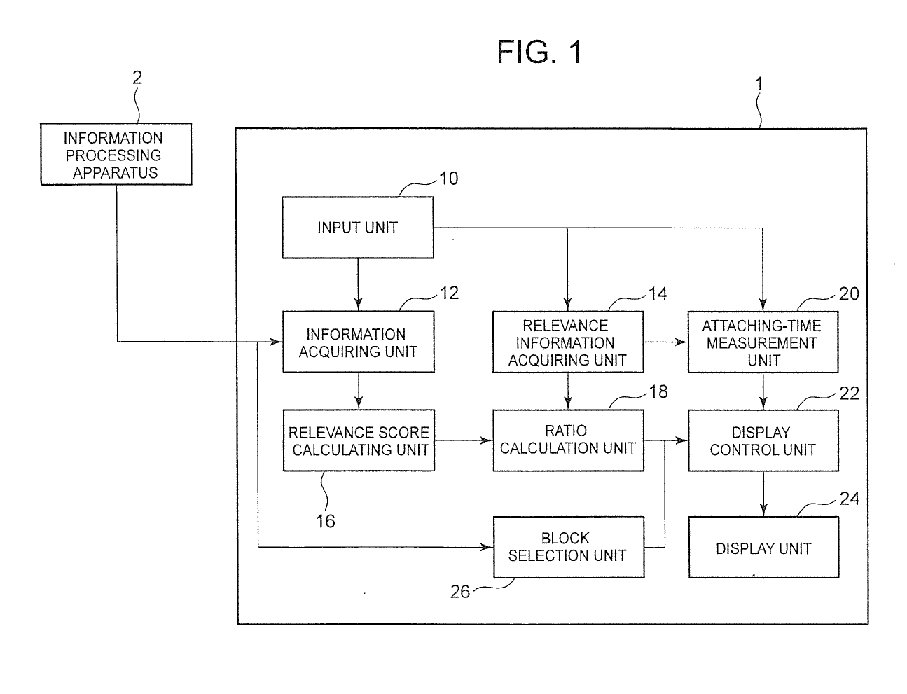

FIG. 1 shows an example of the functional block configuration of the digital information analysis system according to the example.

The digital information analysis system 1 includes an input unit 10 that accepts input from the outside, an information acquiring unit 12 that acquires digital information stored in the information processing apparatus 2, a relevance information acquiring unit 14 that acquires relevance information to be attached to digital information by a classifier, a relevance score calculating unit 16 that calculates a relevance score determined according to relevance between digital information and a predetermined specific matter, and a ratio calculation unit 18 that calculates, for each predetermined range of relevance scores, a ratio of the number of pieces of relevance information, attached to digital information included in each range, to the total number of pieces of digital information having relevance scores included in the range.

The digital information analysis system 1 further includes an attaching-time measurement unit 20 that measures the time required for the classifier to attach relevance information, a display control unit 22 that controls the display of a display unit 24 that displays each predetermined range of relevance scores, and a block selection unit 26 that selects any one of multiple blocks corresponding to each predetermined range of relevance scores.

For example, when digital information is a document file, the relevance score is a value indicative of relevance between the document and a predetermined specific matter. It shows that the larger the value of the relevance score, the higher the relevance between the digital information and the predetermined specific matter. The relevance score is calculated based on such as keywords or related terms included in digital information.

### Information Processing Apparatus 2

The information processing apparatus 2 has a digital information storing unit that stores multiple pieces of digital information and an information output unit that outputs digital information to the outside. The digital information storing unit stores multiple pieces of digital information such as document files including text information, text files, or e-mail. In response to a request from the information acquiring unit 12, the digital information storing unit supplies predetermined digital information to the information acquiring unit 12. The digital information analysis system 1 and the information processing apparatus 2 are connected to be communicable with each other through a communication network such as the Internet or a wired or wireless network such as a LAN. The digital information analysis system 1 can include part or the whole of the functions and configuration of the information processing apparatus 2.

### Input Unit 10

The input unit 10 accepts input from the outside in association with a classifier identifier to uniquely identify a classifier. Specifically, the input unit 10 accepts the input of relevance information to be attached to digital information by the classifier in association with the classifier identifier, and the digital information (or a digital information identifier to uniquely identify the digital information). The relevance information includes first relevance information indicating that the digital information and a predetermined specific matter have relevance to each other, and second relevance information indicating that the digital information and the predetermined specific matter have no relevance to each other. The first relevance information is, for example, information indicating that the digital information is a “HOT document” bearing relation to the predetermined specific matter. The second relevance information is, for example, information indicating that the digital information is a “Non-HOT document” bearing no relation to the predetermined specific matter. The input unit 10 supplies the input relevance information to the relevance information acquiring unit 14 in association with the classifier identifier. The input unit 10 further supplies information, indicative of the time when the classifier starts inputting relevance information for one piece of digital information, to the attaching-time measurement unit 20 in association with the classifier identifier.

### Information Acquiring Unit 12

The information acquiring unit 12 acquires digital information from the information processing apparatus 2. Specifically, the information acquiring unit 12 acquires, from the information processing apparatus 2, digital information to which relevance information is to be attached by the classifier. For example, the information acquiring unit 12 acquires digital information from the information processing apparatus 2 based on the digital information identifier to identify the digital information input to the input unit 10. The information acquiring unit 12 supplies the acquired digital information to the relevance score calculating unit 16 in association with the classifier identifier.

### Relevance Information Acquiring Unit 14

The relevance information acquiring unit 14 acquires from the input unit 10 relevance information to be attached to each of the multiple pieces of digital information manually by the classifier. The relevance information acquiring unit 14 acquires relevance information in association with the classifier identifier. The relevance information acquiring unit 14 supplies relevance information to be attached to one piece of digital information to the ratio calculation unit 18 in association with the classifier identifier and the digital information identifier for the one piece of digital information. The relevance information acquiring unit 14 further supplies information, indicative of the time of acquiring the relevance information, to the attaching-time measurement unit 20 in association with the classifier identifier.

### Relevance Score Calculating Unit 16

The relevance score calculating unit 16 calculates for each of the multiple pieces of digital information a relevance score determined according to relevance between each of the multiple pieces of digital information and a predetermined specific matter. The relevance score calculating unit 16 automatically calculates the relevance score based on the content of the digital information. Specifically, the relevance score calculating unit 16 performs morphological analysis of text data and the like included in one piece of digital information. Then, the relevance score calculating unit 16 calculates a relevance score for one piece of digital information based on the correspondence relation between a predetermined specific matter and a morpheme having high relevance to the specific matter.

For example, the relevance score calculating unit 16 performs morphological analysis of text data included in the digital information. Then, the relevance score calculating unit 16 calculates the relevance score based on the evaluation value of each morpheme itself obtained by the morphological analysis, the number of morphemes included in the digital information, the appearance frequency of each morpheme in the digital information, the evaluation value of each related term included in the digital information, the number of related terms included in the digital information and/or the appearance frequency of each related term in the digital information. As an example, the relevance score calculating unit 16 calculates a higher relevance score as the evaluation value of a morpheme is larger, as the number of morphemes included in the digital information is larger, and as the appearance frequency of each morpheme in the digital information is higher. Similarly, the relevance score calculating unit 16 calculates a higher relevance score as the evaluation value of each related term included in the digital information is larger, as the number of related terms included in the digital information is larger, and as the appearance frequency of each related term in the digital information is higher.

Note that a related term is, for example, a morpheme the evaluation value of which is larger than or equal to a predetermined value among morphemes included in common in the multiple pieces of digital information associated with the first relevance information and the appearance frequencies of which are higher than or equal to a predetermined frequency. The appearance frequency means the proportion of included related terms to the total number of morphemes included in one piece of digital information. Note that the relevance score calculating unit 16 can include a database for morphemes having relevance to a predetermined specific matter. In this case, the relevance score calculating unit 16 can refer to the database to determine whether a morpheme has relevance to the predetermined specific matter. Then, the relevance score calculating unit 16 can calculate a relevance score using morphemes having relevance to the predetermined specific matter. The relevance score calculating unit 16 supplies the calculated relevance score to the ratio calculation unit 18.

### Ratio Calculation Unit 18

The ratio calculation unit 18 calculates for each predetermined range of relevance scores a ratio of the number of pieces of relevance information, attached to digital information included in each range, to the total number of pieces of digital information having relevance scores included in the range. For example, the ratio calculation unit 18 can calculate a ratio based on the number of pieces of first relevance information attached to digital information. When relevance scores fall within a numeric range from “0 (zero)” to “X (X is a positive number of 1 or more)”, the predetermined range of relevance scores is a range obtained by delimiting the numeric range at predetermined intervals. As an example, the predetermined range is each of multiple ranges obtained by delimiting the relevance scores at every 200 points. The numeric range to delimit the relevance scores can be changed arbitrarily.

Specifically, the ratio calculation unit 18 calculates a ratio through the following processes: First, the ratio calculation unit 18 determines which of the first relevance information and the second relevance information is associated with the digital information based on information received from the relevance information acquiring unit 14. Further, the ratio calculation unit 18 figures out a relevance score for each piece of digital information based on information received from the relevance score calculating unit 16. Then, the ratio calculation unit 18 measures the total number of pieces of digital information included in one range of relevance scores. Next, among the pieces of digital information included in the one range of relevance scores, the ratio calculation unit 18 measures the number of pieces of digital information to which the first relevance information is attached. Then, the ratio calculation unit 18 divides the number of pieces of digital information, to which the first relevance information is attached, by the total number of pieces of digital information included in the one range of relevance scores to calculate a ratio in association with the classifier identifier.

As an example, a description will be provided for when the ratio calculation unit 18 calculates a ratio in a score range of relevance scores not less than 6200 points and less than 6400 points. The ratio calculation unit 18 measures the number of pieces of digital information (hereinafter referred to as “A”) included in the range of relevance scores not less than 6200 points and less than 6400 points among the multiple pieces of digital information. Then, the ratio calculation unit 18 measures the number of pieces of digital information (hereinafter referred to as “B”), to which information indicative of “HOT document” is attached, among the pieces of digital information included in the range of relevance scores not less than 6200 points and less than 6400 points. Then, the ratio calculation unit 18 calculates the value of “B/A” as the ratio. The ratio calculation unit 18 supplies information indicative of the calculated ratio to the display control unit 22 in association with the score range in which the ratio is calculated, and the classifier identifier.

### Attaching-Time Measurement Unit 20

The attaching-time measurement unit 20 measures the time required to attach relevance information to one piece of digital information. Specifically, the attaching-time measurement unit 20 measures the required time from a time point of receiving information indicative of the time when one classifier started inputting relevance information for one piece of digital information from the input unit 10 until a time point of receiving information indicative of the time when relevance information attached to the one piece of digital information has been acquired from the relevance information acquiring unit 14. The attaching-time measurement unit 20 measures the time required to attach relevance information to each of the multiple pieces of digital information, respectively. Further, the attaching-time measurement unit 20 measures the time required to attach relevance information in association with the classifier identifier. Then, the attaching-time measurement unit 20 calculates for each classifier identifier a rate of attaching relevance information on a classifier identified by the classifier identifier (e.g., the time required for attaching relevance information to one piece of digital information). The attaching-time measurement unit 20 supplies, to the display control unit 22, information indicative of the measured time and/or the calculated rate in association with the classifier identifier.

### Display Control Unit 22 and Display Unit 24

The display unit 24 displays multiple blocks associated with each predetermined range of relevance scores on a display device such as a display capable of displaying digital information. Specifically, the display unit 24 displays the multiple blocks by changing the hue, brightness, or saturation of each block based on information indicative of the ratio received by the display control unit 22 from the ratio calculation unit 18. The display unit 24 displays the multiple blocks for each classifier identified by the classifier identifier. In other words, the display control unit 22 controls the display unit 24 to display each block in such a state that the hue, brightness, or saturation of the multiple blocks are changed according to the ratio received from the ratio calculation unit 18 for each of multiple classifiers. For example, the display control unit 22 displays each block by gradually changing the color of the block from a cold color to a warm color as the ratio increases from 0% to 100%.

Further, based on information received from the attaching-time measurement unit 20 for each classifier identified by the classifier identifier, the display unit 24 displays a classification rate as a rate of each classifier to classify digital information. The display unit 24 displays a classification rate calculated from information indicative of the measured time received from the attaching-time measurement unit 20 together with the multiple blocks. When displaying the classification rate, the display unit 24 can display the classification rate in the form of a graph by choosing the abscissa as the time axis and the ordinate as the axis of classification rate. The time span on the time axis can be changed arbitrarily.

### Block Selection Unit 26

The block selection unit 26 selects any one of the multiple blocks associated with each predetermined range of relevance scores according to an instruction from the outside. The display control unit 22 controls the display unit 24 to display digital information having relevance scores included in a score range corresponding to the block selected by the block selection unit 26. This enables the digital information analysis system 1 to display the content of digital information included in each of the multiple blocks displayed on the display unit 24.

### Outline of Display Screen 260 of Digital Information Analysis System 1

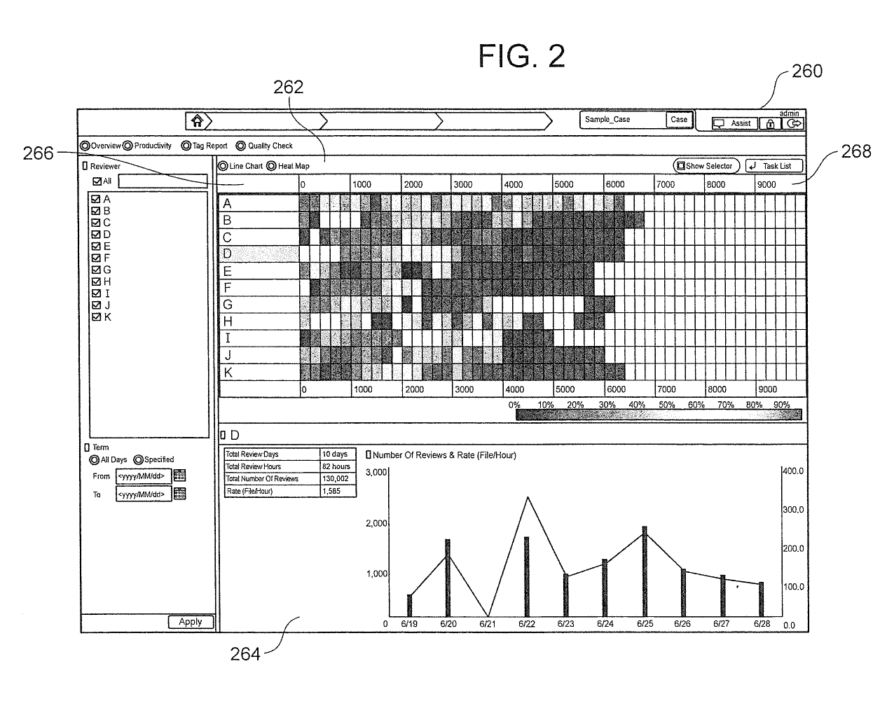

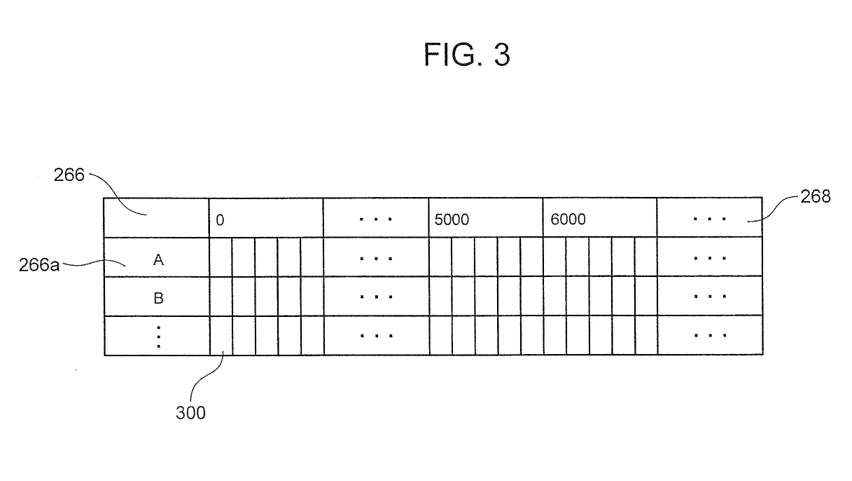

FIG. 2 shows an example of a display screen of the digital information analysis system according to an example. FIG. 3 schematically shows an outline of part of the display screen of the digital information analysis system according to an example.

A display screen 260 displayed on the display unit 24 under the control of the display control unit 22 has a display area 262 to display multiple blocks and the ratio associated with each predetermined range of relevance scores, respectively. The display area 262 includes a classification rate area 264 to show classification rates, a classifier column 266 to show the names or titles of multiple classifiers, and a relevance score column 268 to show relevance scores. As an example, the digital information analysis system 1 has the relevance score column 268 having multiple blocks in each predetermined score range in the horizontal direction of the display area 262. Then, the digital information analysis system 1 has the classifier column 266 to show classifiers in the vertical direction of the display area 262. Thus, the relevance score column 268 is provided for each classifier.

As an example, referring to FIG. 3, the display unit 24 of the digital information analysis system 1 displays a classifier name 266a of one classifier in the classifier column 266. The relevance score column 268 shows multiple blocks along one direction of the display unit 24 (the horizontal direction in the example of FIG. 3). The display unit 24 arranges and displays multiple blocks in order of increasing relevance scores in each predetermined score range. In the example of FIG. 3, the display unit 24 arranges and displays the multiple blocks to increase the relevance scores in increments of 200 points from left to right.

Therefore, relevance scores having a predetermined score range are associated with each block. Specifically, when a score range of relevance scores not less than x points and less than x+y points (where x and y are positive numbers of 0 or more, and x≠y) is associated with one block, a score range of relevance scores not less than x+y points and less than x+y+z points (where z is a positive number of 0 or more, and y≠z) is associated with another block adjacent to the one block. For example, when relevance scores not less than 0 points and less than 200 points are associated with one block, relevance scores not less than 200 points and less than 400 points are associated with a block adjacent to the one block. In other words, the score range stays constant in this example.

When receiving information indicative of a ratio from the ratio calculation unit 18 in association with the classifier identifier, the display control unit 22 controls the display unit 24 to display a block 300 in the relevance score column 268 corresponding to relevance scores of digital information used in calculating the ratio for a classifier identified by the classifier identifier in the classifier column 266 by changing the hue, brightness, or saturation of the block 300. For example, the display control unit 22 displays the block by gradually changing the color of the block from a cold color (e.g., blue) to a warm color (e.g., red) as the ratio calculated by the ratio calculation unit 18 increases from 0% to 100%. The digital information having a high relevance score is digital information having high relevance to the predetermined specific matter. Therefore, it is preferred that the color of a block corresponding to a high relevance score should be a warmer color as the relevance score becomes higher. Therefore, the good or bad of the classification accuracy of each classifier can be grasped at a glance by referring to the color of each block displayed on the display unit 24.

### Outline of Processing Flow of Digital Information Analysis System

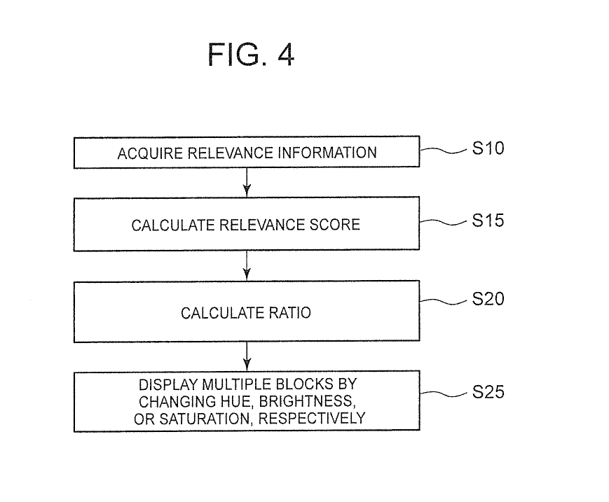

FIG. 4 shows an example of a processing flow of the digital information analysis system according to an example.

First, the relevance information acquiring unit 14 acquires relevance information attached through the input unit 10 to digital information acquired by the information acquiring unit 12 (step 10: step is abbreviated as “S” below). The relevance information acquiring unit 14 acquires relevance information in association with the classifier identifier for a classifier who has input the relevance information to the input unit 10. The relevance information acquiring unit 14 supplies the acquired relevance information to the ratio calculation unit 18. Further, the relevance score calculating unit 16 calculates a relevance score of the digital information acquired by the information acquiring unit 12 (S15). The relevance score calculating unit 16 supplies the calculated relevance score to the ratio calculation unit 18.

The ratio calculation unit 18 measures the total number of pieces of digital information having relevance scores included in the predetermined score range of relevance scores. Then, the ratio calculation unit 18 measures the number of pieces of digital information as digital information having relevance scores included in the score range and associated with the first relevance information. Next, the ratio calculation unit 18 calculates a ratio by dividing the number of pieces of digital information associated with the first relevance information by the total number measured (S20). The ratio calculation unit 18 calculates a ratio for each of multiple score ranges, respectively. The ratio calculation unit 18 supplies information indicative of the calculated ratio to the display control unit 22.

The display control unit 22 displays the multiple blocks on the display unit 24 by changing the hue, brightness, or saturation thereof based on the information on the ratios received from the ratio calculation unit 18, respectively (S25). The display control unit 22 displays the multiple blocks for each of the multiple classifiers, respectively.

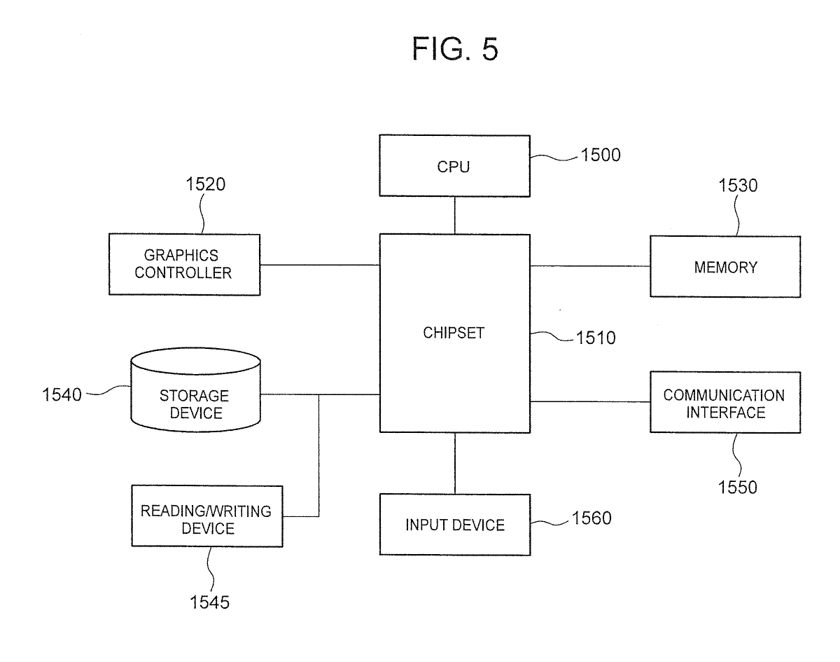

FIG. 5 shows an example of the hardware configuration of the digital information analysis system according to an example.

The digital information analysis system 1 includes a CPU 1500, a graphics controller 1520, a memory 1530 such as a Random Access Memory (RAM), a Read-Only Memory (ROM) and/or a flash ROM, a storage device 1540 that stores data, a reading/writing device 1545 that reads data from a recording medium and/or writing data to a recording medium, an input device 1560 that inputs data, a communication interface 1550 that transmits and receives data to and from external communication devices, and a chipset 1510 that connects the CPU 1500, the graphics controller 1520, the memory 1530, the storage device 1540, the reading/writing device 1545, the input device 1560, and the communication interface 1550 to be communicable with one another.

The chipset 1510 interconnects the memory 1530, the CPU 1500 accessing the memory 1530 to perform predetermined processing, and the graphics controller 1520 for controlling the display of an external display device to ensure the delivery of data among respective components. The CPU 1500 operates based on a program stored in the memory 1530 to control each component. The graphics controller 1520 displays images on a predetermined display device based on image data temporarily accumulated in a buffer provided in the memory 1530.

Further, the chipset 1510 connects the storage device 1540, the reading/writing device 1545, and the communication interface 1550. The storage device 1540 stores programs and data used by the CPU 1500 in the digital information analysis system 1. The storage device 1540 is, for example, a flash memory. The reading/writing device 1545 reads a program and/or data from a storage medium storing the program and/or data, and stores the read program and/or data in the storage device 1540. The reading/writing device 1545 is, for example, acquires a predetermined program from a server on the Internet through the communication interface 1550, and stores the acquired program in the storage device 1540.

The communication interface 1550 exchanges data with external devices through a communication network. Further, when the communication network is down, the communication interface 1550 can exchange data with the external devices not through the communication network. Then, the input device 1560 such as a keyboard, a tablet, or a mouse is connected to the chipset 1510 through a predetermined interface.

A digital information analysis program for the digital information analysis system 1 to be stored in the storage device 1540 is provided to the storage device 1540 through a communication network such as the Internet, or a recording medium such as a magnetic recording medium or an optical recording medium. Then, the digital information analysis program for the digital information analysis system 1 stored in the storage device 1540 is executed by the CPU 1500.

The digital information analysis program executed by the digital information analysis system 1 works with the CPU 1500 to cause the digital information analysis system 1 to function as the input unit 10, the information acquiring unit 12, the relevance information acquiring unit 14, the relevance score calculating unit 16, the ratio calculation unit 18, the attaching-time measurement unit 20, the display control unit 22, the display unit 24, and the block selection unit 26 described from FIG. 1 to FIG. 4.

The digital information analysis system 1 can provide a map display (e.g., heat map display) of the classification accuracy of each classifier so that the accuracy of multiple classifiers, i.e. whether proper relevance information is attached to digital information can be grasped at a glance. Then, the digital information analysis system 1 can change the display state of blocks according to the magnitude of the relevance score based on the fact that digital information has higher relevance to the predetermined specific matter as the relevance score of the digital information becomes higher. In other words, according to the digital information analysis system 1, the color of a block can be changed and displayed according to the ratio so that the classification accuracy of digital information of each classifier can be grasped at a glance merely by referring to the color of each block of relevance scores. Thus, according to the digital information analysis system 1, information that improves classification accuracy can be provided to the classifier since the classification accuracy of digital information of each classifier can be visually displayed, information for improving classification accuracy can be provided to the classifier.

Further, since the digital information analysis system 1 displays the rate of one classifier to attach relevance information to digital information in the classification rate area 264, the classification rate of the classifier can be grasped at a glance together with the classification accuracy of the classifier. Therefore, for example, even when the classification accuracy of one classifier is high, the digital information analysis system 1 can grasp other characteristics of the classifier such as a slow classification rate.

While examples have been described, the aforementioned examples are not intended to limit this disclosure according to the scope of the appended claims. It should also be noted that all the combinations of the features described in the examples are not necessarily essential. The technical elements may be applied independently or can be applied in the form of being divided into multiple components such as program components and hardware components.

1-7. (canceled)

8. A digital information analysis system comprising:
a relevance information acquiring unit that acquires relevance information attached by a classifier to each of a plurality of pieces of digital information and indicative of relevance between the digital information and a predetermined specific matter;
a relevance score calculating unit that calculates, for each of the plurality of pieces of digital information, a relevance score determined according to relevance between each of the plurality of pieces of digital information and the predetermined specific matter;
a ratio calculation unit that calculates, for each predetermined range of relevance scores, a ratio of the number of pieces of relevance information, attached to the digital information included in the range, to the total number of pieces of digital information having the relevance scores included in each range; and
a display unit that displays a plurality of blocks associated with each range by changing hue, brightness, or saturation based on the ratio.

9. The digital information analysis system according to claim 8, wherein
the relevance information includes first relevance information indicating that the digital information and the predetermined specific matter have relevance to each other, and second relevance information indicating that the digital information and the predetermined specific matter have no relevance to each other, and
the ratio calculation unit calculates the ratio based on the number of pieces of first relevance information.

10. The digital information analysis system according to claim 8, wherein
the relevance information acquiring unit acquires the relevance information in association with a classifier identifier that identifies the classifier, and
the display unit displays the plurality of blocks for each classifier identified by the classifier identifier.

11. The digital information analysis system according to claim 10, further comprising:
an attaching-time measurement unit that measures a time required to attach the relevance information to one piece of digital information,
wherein the display unit displays a classification rate calculated from the time for each classifier identified by the classifier identifier.

12. The digital information analysis system according to claim 8, further comprising:
a block selection unit that selects any of the plurality of blocks,
wherein the display unit displays the digital information having the relevance scores included in the range corresponding to the block selected by the block selection unit.

13. A method of analyzing digital information comprising:
a relevance information acquiring step of acquiring relevance information attached by a classifier to each of a plurality of pieces of digital information and indicative of relevance between the digital information and a predetermined specific matter;
a relevance score calculating step of calculating for each of the plurality of pieces of digital information a relevance score determined according to relevance between each of the plurality of pieces of digital information and the predetermined specific matter;
a ratio calculation step of calculating for each predetermined range of relevance scores a ratio of the number of pieces of relevance information, attached to the digital information included in the range, to the total number of pieces of digital information having the relevance scores included in each range; and
a display step of displaying a plurality of blocks associated with each range by changing hue, brightness, or saturation based on the ratio.

14. A non-transitory computer readable storage media that causes a computer to realize:
a relevance information acquiring function of acquiring relevance information attached by a classifier to each of a plurality of pieces of digital information and indicative of relevance between the digital information and a predetermined specific matter;
a relevance score calculating function of calculating for each of the plurality of pieces of digital information a relevance score determined according to relevance between each of the plurality of pieces of digital information and the predetermined specific matter;
a ratio calculation function of calculating for each predetermined range of relevance scores a ratio of the number of pieces of relevance information, attached to the digital information included in the range, to the total number of pieces of digital information having the relevance scores included in each range; and
a display function of displaying a plurality of blocks associated with each range by changing hue, brightness, or saturation based on the ratio.

15. The digital information analysis system according to claim 9, wherein
the relevance information acquiring unit acquires the relevance information in association with a classifier identifier that identifies the classifier, and
the display unit displays the plurality of blocks for each classifier identified by the classifier identifier.

16. The digital information analysis system according to claim 9, further comprising:
a block selection unit that selects any of the plurality of blocks,
wherein the display unit displays the digital information having the relevance scores included in the range corresponding to the block selected by the block selection unit.

17. The digital information analysis system according to claim 10, further comprising:
a block selection unit that selects any of the plurality of blocks,
wherein the display unit displays the digital information having the relevance scores included in the range corresponding to the block selected by the block selection unit.

18. The digital information analysis system according to claim 11, further comprising:
a block selection unit that selects any of the plurality of blocks,
wherein the display unit displays the digital information having the relevance scores included in the range corresponding to the block selected by the block selection unit.
